(19) United States
(12) Patent Application Publication
(10) Pub. No.: US 2012/0318147 A1
(43) Pub. Date: Dec. 20, 2012

(54) ANTIMICROBIAL AND CARBON TREATED INDOOR AIR FILTER

(76) Inventors: James Lee Gates, Daphne, AL (US); Richard Joseph Scott, Fairhope, AL (US)

(21) Appl. No.: 13/161,397

(22) Filed: Jun. 15, 2011

(51) Int. Cl. B01D 53/04

(52) U.S. Cl. 96/154

(57) ABSTRACT

An indoor air filter is disclosed. The filter includes non-woven fibers, carbon, and an antimicrobial. The carbon and the antimicrobial are bonded to the fibers to form a filter media. The filter media is pleated. The carbon is activated. The antimicrobial can be silver. The non-woven fibers can be synthetic, and the filter media can be a mechanical filter media.

### FIELD OF THE INVENTION

This invention relates to an indoor air filter. More specifically, this invention relates to an indoor air filter wherein an antimicrobial and carbon are bonded to non-woven fibers to form a filter media.

### BACKGROUND OF THE INVENTION

Air filters used in heating, ventilating and air conditioning (HVAC) systems are designed to collect a variety of airborne contaminants. Among the contaminants trapped by the air filter are living microorganisms, in a viable or static form, which under the right conditions can proliferate. These microorganisms include mold, mildew, fungi, yeasts, algae and bacteria, ranging in size.

A properly designed, high efficiency air filter can greatly reduce airborne concentrations of these harmful and respirable particulates. As a filter collects dust, however, more and more of these microorganisms become concentrated in the filter media over time.

Antimicrobial treatments for air filtration products have recently become a topic of considerable interest. These antimicrobial agents, which are intended to destroy or inhibit the growth of microorganisms, have been used in commercial and industrial surface applications (e.g. walls, carpets, etc.) for several years. Applied to air filter media, the treatments purport to improve indoor air quality by destroying a broad range of microorganisms and preventing the growth of microbes in the dirty filter. However, the antimicrobial chemicals applied to filter media have had very limited success. These chemicals, which are affected by humidity, air flow and evaporation, are subject to change, and, as a result, lose their effectiveness over time. The antimicrobial properties do not last the life of the filter. Also, chemical vapors in the air can have chemical reactions with other chemicals. Further, many of these antimicrobials are hazardous to health, and can damage the environment. For example, many filter media manufacturers use pesticide-related chemicals as an antimicrobial treatment.

What is needed is an indoor air filter that inhibits microorganisms over the life of the filter and improves air quality.

### SUMMARY OF THE INVENTION

The present invention is directed to an indoor air filter. In one embodiment of the present invention, the filter comprises non-woven fibers, activated carbon, and an antimicrobial. The carbon and the antimicrobial are bonded to the non-woven fibers to form a filter media. The filter media is pleated. In one embodiment, the antimicrobial is silver. In one embodiment, the fibers are synthetic. The synthetic fibers can be polypropylene fibers or polyester.

The indoor air filter can comprise an optional metal support grid. The filter media is bonded to the metal support grid. In one embodiment, the metal support grid is a 30 gauge galvanized, corrosion resistant metal support grid.

The indoor air filter can also comprise an optional filter frame. The filter media and the metal support grid are bonded to the filter frame. In one embodiment, the filter frame is a moisture resistant double wall beverage board frame.

In another embodiment of the present invention, an indoor air filter is disclosed. The filter comprises non-woven synthetic fibers, activated carbon, and an antimicrobial. The antimicrobial is silver, and the carbon and the silver are bonded to the fibers to form a mechanical filter media. The filter media is pleated.

In another embodiment of the present invention, an indoor air filter is disclosed. The filter comprises non-woven synthetic fibers, activated carbon, and an antimicrobial. The antimicrobial is silver, and the carbon and the silver are bonded to the fibers to form a mechanical filter media. The filter media is pleated. The filter further includes a metal support grid. The filter media is bonded to the metal support grid. The filter also comprises a filter frame. The filter media and the metal support grid are bonded to the filter frame.

### BRIEF DESCRIPTION OF THE DRAWINGS

FIG. 1 shows an indoor air filter, in accordance with one embodiment of the present invention.

### DETAILED DESCRIPTION OF THE PREFERRED EMBODIMENTS

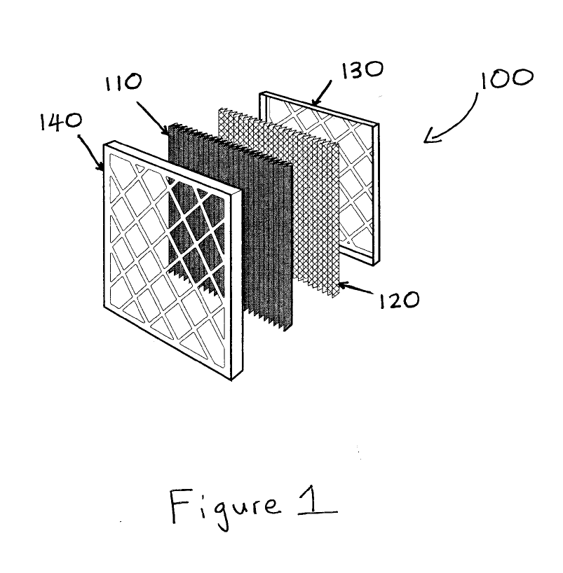

FIG. 1 shows an indoor air filter 100, in accordance with one embodiment of the present. The filter 100 includes a filter media 110, an optional metal support grid 120, and optional filter frames 130 and 140. The filter media is pleated. The pleated filters comprise depths from 1″ to 6″. Pleat spacing is controlled to maximize surface area and dust holding capacity.

The filter media 110 comprises non-woven fibers, activated carbon, and an antimicrobial. The carbon and the antimicrobial are bonded to the fibers to form the filter media 110. Activated carbon adsorbs a wide array of Volatile Organic Compounds and smog while maintaining a low resistance to air flow. In one embodiment, the activated carbon is a fine carbon powder. These carbon particles adhere to the fibers through a strong molecular bond and do not require pore-clogging adhesives. The filter media 110 is resistant to a wide range of chemicals, does not absorb moisture, and will not support microbial growth.

In one embodiment, the antimicrobial is silver. In one embodiment, the non-woven fibers are synthetic fibers, such as polypropylene fibers and polyester.

The silver and carbon can be bonded to the fiber media using a binder process. As one example, a binder material is used for taking non-woven fibers and creating a bond between the fibers. Then silver is added with a dispersant to the binder process, so that the silver is evenly dispersed among the media. Liquid is added and made into foam, where the media goes through a foam bath, resulting in the binders and the silver being bound to the media. A series of dryers are used to cure the liquid binders. The silver is bound with the fibers in the same process that the fibers are bound with each other. Also, carbon is bound to the media such that its surface area is maximized.

The metal support grid 120 is an optional feature of the filter 100. The filter media 110 is bonded to the metal grid 120. In one embodiment, the metal grid 120 is a 30 gauge galvanized, corrosion resistant metal support grid. The metal grid 120 is provided for structural purposes. However, a self-supporting pleated media does not require the use of a metal support grid for structural purposes.

The filter frames 130 and 140 are also optional features of the filter 100. The filter media 110 and the metal support grid 120 are bonded to the filter frames 130 and 140. In one embodiment, the filter frames are moisture resistant double wall beverage board frames. The filter frames 130 and 140 allow for easier handling of the filter 100 and prevent dust bypass. However, the filter frames 130 and 140 are not required for handling purposes if the filter media 110 include clips, hooks or latches.

### EXAMPLE

Antimicrobial Results

a. Antimicrobial activity against Escherichia Coli after 0 and 24 hour incubation.

Pure metallic polymer stabilized silver particles (SmartSilver™ WS) provided by NanoHorizons, Inc., were added into a non-woven fabric binder system. The silver was loaded at 250 ppm into the binder. On a mass basis the binder is 20% the total media weight. Thus, the concentration of silver in the total media is 50 ppm. The silver nanoparticles are polymer stabilized. Once the additive is mixed with the binder system, the polymer stabilizer intermingles with the polymer of the binder. Once dried the additive is permanently bound within the media binder. The active ingredient is a pure metallic silver particle.

The results for antimicrobial activity against E. Coli after 0 (initial) and 24 (final) hour incubation using ASTM E2149-10 are detailed in the following table. Surviving bacteria were counted as CFU (Colony Forming Units). As shown in the table, the addition of silver to the media conferred antibacterial activity.

| | Initial | Final | % |
|---|---|---|---|
| | Concentration | Concentration | Reduction |
| Sample | (CFU/ml) | (CFU/ml) | (To Sample) |
| 250 ppm Silver* | 4.40 × 10⁵ | <1.00 × 10² | >99.9% |
| 500 ppm Silver* | 4.40 × 10⁵ | <1.00 × 10² | >99.9% |
| 750 ppm silver* | 4.40 × 10⁵ | <1.00 × 10² | >99.9% |

*Silver content in binder. Binder is approximately 25% of total mass.

As mentioned, the pleated filter media can be used with a filter frame. Alternatively, the media can be used without a frame. Without the frame, the filter media can be used in a room air conditioning system that has an internal frame. In another embodiment, the filter media can be used with a room air cleaner that has a filter in it. The filter media can fit into existing filter housings so fume and odor control is available without costly retro-fitting or expensive housings and fans. The filter media can be used for both residential and commercial purposes. Also, the mechanical aspects of the media do not require an electrostatic charge or enhancement in order to achieve its filtration efficiency.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modification may be made in the embodiments chosen for illustration without departing from the spirit and scope of the invention

What is claimed is:

1. An indoor air filter comprising:
a. non-woven fibers;
b. activated carbon; and
c. an antimicrobial, wherein the carbon and the antimicrobial are bonded to the fibers to form a filter media, and wherein the filter media is pleated.

2. The indoor air filter of claim 1 wherein the antimicrobial is silver.

3. The indoor air filter or claim 1 wherein the fibers are synthetic.

4. The indoor air filter of claim 3 wherein the synthetic fibers are one of polypropylene fibers and polyester.

5. The indoor air filter of claim 1 further comprising a metal support grid, wherein the filter media is bonded to the metal support grid.

6. The indoor air filter of claim 5 wherein the metal support grid is a 30 gauge galvanized, corrosion resistant metal support grid.

7. The indoor air filter of claim 5 further comprising a filter frame, wherein the filter media and the metal support grid are bonded to the filter frame.

8. The indoor air filter of claim 7 wherein the filter frame is a moisture resistant double wall beverage board frame.

9. An indoor air filter comprising:
a. non-woven synthetic fibers;
b. activated carbon; and
c. an antimicrobial, wherein the antimicrobial is silver, wherein the carbon and the silver are bonded to the fibers to form a mechanical filter media, and wherein the filter media is pleated.

10. The indoor air filter of claim 9 wherein the synthetic fibers are one of polypropylene fibers and polyester.

11. The indoor air filter of claim 9 further comprising a metal support grid, wherein the filter media is bonded to the metal support grid.

12. The indoor air filter of claim 11 wherein the metal support grid is a 30 gauge galvanized, corrosion resistant metal support grid.

13. The indoor air filter of claim 11 further comprising a filter frame, wherein the filter media and the metal support grid are bonded to the filter frame.

14. The indoor air filter of claim 13 wherein the filter frame is a moisture resistant double wall beverage board frame.

15. An indoor air filter comprising:
a. non-woven synthetic fibers;
b. activated carbon;
c. an antimicrobial, wherein the antimicrobial is silver, wherein the carbon and the silver are bonded to the fibers to form a mechanical filter media, and wherein the filter media is pleated;
d. a metal support grid, wherein the filter media is bonded to the metal support grid; and
e. a filter frame, wherein the filter media and the metal support grid are bonded to the filter frame.
